(19) United States
(12) Patent Application Publication
(10) Pub. No.: US 2002/0146149 A1
(43) Pub. Date: Oct. 10, 2002

(54) Space filling quantizers for digital watermarking

(76) Inventor: Hugh L. Brunk, Portland, OR (US)

Correspondence Address: DIGIMARC CORPORATION, 19801 SW 72ND AVENUE, SUITE 100, TUALATIN, OR, 97062, US

(21) Appl. No.: 10/017,463

(22) Filed: Dec. 14, 2001

Related U.S. Application Data
(60) Provisional application No. 60/256,629, filed on Dec. 18, 2000.

(51) Int. Cl. G06K 9/36; G06K 9/38; G06K 9/46

(52) U.S. Cl. 382/100; 382/253

(57) ABSTRACT

A QIM watermark embedder uses a space filling quantizer to imperceptibly embed an auxiliary message signal into a media signal, such as an image, audio or video signal. A specific example of the space filling quantizer is a hexagonal lattice quantizer. A QIM watermark decoder uses a compatible space filling quantizer to decode the auxiliary message signal from a potentially distorted version of the watermarked media signal. The shape filling quantizer enhances the information carrying capacity of the digital watermark.

### RELATED APPLICATION DATA

This patent application claims the benefit of U.S. Provisional application No. 60/256,629, filed Dec. 18, 2000, which is hereby incorporated by reference.

### TECHNICAL FIELD

The invention relates to steganography, data hiding, and digital watermarking.

### BACKGROUND AND SUMMARY

Digital watermarking is a process for modifying physical or electronic media to embed a machine-readable code into the media. The media may be modified such that the embedded code is imperceptible or nearly imperceptible to the user, yet may be detected through an automated detection process. Most commonly, digital watermarking is applied to media signals such as images, audio signals, and video signals. However, it may also be applied to other types of media objects, including documents (e.g., through line, word or character shifting), software, multi-dimensional graphics models, and surface textures of objects.

Digital watermarking systems typically have two primary components: an encoder that embeds the watermark in a host media signal, and a decoder that detects and reads the embedded watermark from a signal suspected of containing a watermark (a suspect signal). The encoder embeds a watermark by altering the host media signal. The reading component analyzes a suspect signal to detect whether a watermark is present. In applications where the watermark encodes information, the reader extracts this information from the detected watermark.

Several particular watermarking techniques have been developed. The reader is presumed to be familiar with the literature in this field. Particular techniques for embedding and detecting imperceptible watermarks in media signals are detailed in the assignee's co-pending application Ser. No. 09/503,881 and U.S. Pat. No. 5,862,260, which are hereby incorporated by reference. A form of watermark embedding referred to as Quantization Index Modulation (QIM) is described in WO9960514A1, SYSTEM, METHOD, AND PRODUCT FOR INFORMATION EMBEDDING USING AN ENSEMBLE OF NON-INTERSECTING EMBEDDING GENERATORS and corresponding U.S. patent application Ser. No. 09/206,806, filed Dec. 7, 1998; which are hereby incorporated by reference.

This invention provides a method of QIM digital watermark embedding using using space filling quantizers. A QIM watermark embedder uses a space filling quantizer to imperceptibly embed an auxiliary message signal into a media signal, such as an image, audio or video signal. A specific example of the space filling quantizer is a hexagonal lattice quantizer.

A QIM watermark decoder uses a compatible space filling quantizer to decode the auxiliary message signal from a potentially distorted version of the watermarked media signal.

### BRIEF DESCRIPTION OF DRAWINGS

FIG. 1 illustrates a block diagram of QIM watermarking.

FIG. 2 illustrates quantizers used for dithered uniform scalar QIM watermarking.

FIG. 3 illustrates an extension of scalar dithered QIM to two dimensions.

FIG. 4 illustrates an example of a sphere packing arrangement to show how to improve the digital watermark message rate for a given watermark distortion constraint.

FIG. 5 compares the performance of space filling QIM performance with and without distortion compensation.

FIG. 6 shows performance of QIM watermarking with three different quantizer types.

FIG. 7 shows performance of distortion compensated QIM watermarking with three different quantizer types.

### DETAILED DESCRIPTION

Introduction

Digital watermarking is both an active area of research and a growing source of commercial activity. Early research focused upon watermarking as a solution to verify ownership of images and other media, but watermarking has since found its way into a variety of applications. Some uses for digital watermarking include counterfeit prevention, broadcast monitoring, brand protection, and enabling of content on the internet.

In these and other applications, digital watermarking allows both the unobtrusive embedding of information into media as well as the capability to reliably recover the information, possibly after application specific degradation of the watermarked media signal (e.g., audio, image, or video). There is a natural tension between requirements of being able to embed a large amount of information, requirements for the embedded information to imperceptibly alter the original source, and requirements of being able to recover the information after severe distortions to the watermarked source signal. Information theory has been applied to the watermarking problem and has been used to determine the space of requirements over which we can hope to build real systems.

Chen and Wornell proposed Quantization index modulation (QIM) as an efficient method of digital watermarking. QIM is used in the information theoretic proofs of watermarking capacity. This capacity can be demonstrated via random coding using a sequence of vector quantizers of increasing block length, with both channel capacity and optimal rate-distortion performance being reached in the limit of infinite quantizer block length. It is tempting to investigate the utility of QIM in practical watermarking situations as well. It is possible that different considerations should be used in the design of quantizers for QIM than for the design of quantizers for compression. Because the quantized values are not digitally encoded in QIM, the number of reconstruction values in each quantizer is not a design constraint, as it is in the design of a conventional quantizer. The lack of a rate constraint in QIM suggests that quantizer design for QIM involves different considerations than does quantizer design for rate-distortion performance. Lookabaugh has identified three types of advantages of vector quantizers vs. scalar quantizers. See T. D. Lookabaugh and R. M. Gray, “High-Resolution Quantization Theory and the Vector Quantizer Advantage,” IEEE Trans. On Information Theory 35, pp. 1020-1033, September 1989. These advantages are called the space-filling, shape, and memory advantages. The space-filling advantage is due to the increasing efficiency with which polytopes can be used to fill space as the dimension increases. The shape advantage involves the marginal distribution of the source signal and the tendency for the typical source distribution to be concentrated in a small volume in high dimensional space. Finally, the memory advantage exploits dependencies between samples of the source signal. This document describes digital watermarking methods that exploit the space-filling advantage in particular, and provides a heuristic argument that the space-filling advantage alone is sufficient to achieve watermark capacity in some situations. QIM performance of some relatively simple quantizers with a space filling gain and with a shape gain are compared and found to support the idea that space-filling gain is significant for QIM applications of quantizers.

The first section provides some notation and a brief review of QIM. Then the next section investigates the construction of vector quantizers for QIM that have a space-filling gain and no shape or memory gain. Final sections present QIM performance results, and the final section presents conclusions.

Notation and Review of QIM

The basic watermarking task is to communicate a watermark message M by modifying a host signal X₁^{N} to produce the watermarked signal S₁^{N}. The watermarked signal then undergoes possible distortions over a watermark signal channel p(Y₁^{N}|S₁^{N}) resulting in the received signal Y₁^{N}. In some cases it will be helpful to consider the noise introduced by the watermark signal channel as additive with variance σ². Throughout this document, the host signal, watermarked signal, and received signal will be assumed to be taken from [symbol] ^{N}, an N-dimensional set of real numbers. An embedding rate Rₘ is used to embed the message in the host signal; accordingly, the message Mε{0, 1, 2, . . . , 2^{NRm}−1}. It will be assumed that the distortion introduced by the watermark signal channel is independent of the message, and that the host signal is also independent of the message. The goal in the design of the watermarking system is to minimize the error probability in transmitting the message subject to a constraint Dₘ on the distortion introduced by the watermarked signal. The distortion measure used here will be the per letter squared error:

$$D ( {S}_{1}^{N} , {X}_{1}^{N} ) = \frac{1}{N} {\sum }_{i = 1}^{N} {( {S}_{i} - {X}_{i} )}^{2} .$$

QIM Watermarking

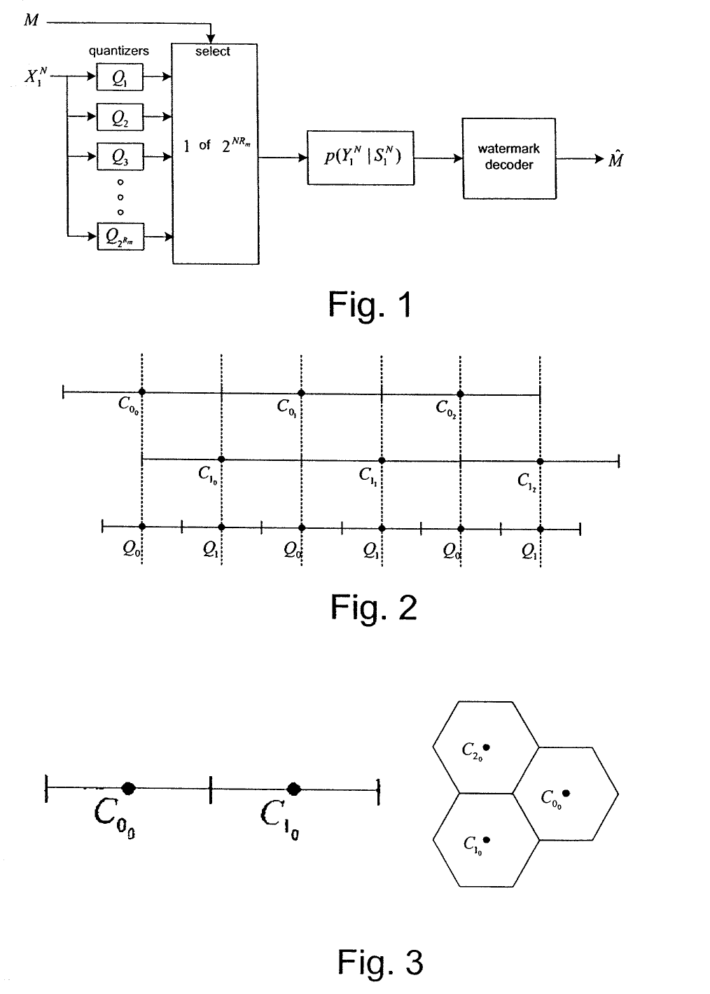

FIG. 1 shows how QIM can be used to implement the watermarking task. The watermark encoder associates a separate quantizer Q with each of the possible 2^{NRm} messages. It chooses the quantizer Qₘ corresponding to the input message M and uses this quantizer to quantize samples of the host signal, producing the watermarked signal S₁^{N}. These samples may be spatial, frequency, time or other transform domain features of the media signal. After this signal is passed through the channel, the watermark decoder's task is to estimate the message M based upon the received signal Y₁^{N}. This is done by quantizing Y₁^{N} using each of the 2^{NRm} quantizers available to the encoder. The corresponding distortion is calculated for each quantizer, and the quantizer resulting in the lowest distortion is assumed to be the one most likely to have been used by the encoder. Then the decoder chooses the message \hat{M}, which corresponds to this quantizer, as its estimate of the original message M. The watermark encoder can be defined by

F(m,x)=Qₘ(x),

and the decoder by

$$G ( y ) = arg {min}_{0 \leq m \leq {2}^{{NR}_{m - 1}}} D ( y , {Q}_{m} ( y ) )$$

FIG. 2 illustrates dithered uniform scalar QIM. The message consists of a single bit that causes the encoder to choose between quantizer Q₀, shown at top, and quantizer Q₁, shown below. The decoder effectively uses the quantizer shown at the bottom of the figure to decide between the two possible message values.

Distortion

Chen and Wornell propose a postprocessing technique for QIM that they call distortion compensated QIM. See B. Chen and G. W. Wornell, “Preprocessed and Postprocessed Quantization Index Modulation Methods for Digital Watermarking,” in Security and Watermarking of Multimedia Contents II, P. W. Wong and E. J. Delp, eds., Proc. SPIE 3971, pp. 48-59, 2000. They associate a scale factor

$$\frac{Δ}{α}$$

with each quantizer and use the parameter α to add part of the quantization error back to the watermarked source signal:

F_{DC}(m,x)=Qₘ(x,Δ/α)+(1−α)[x−Qₘ(x,Δ/α)]

The parameter a is restricted to [0, 1], ensuring that D(y, Qₘ(y, Δ/α)) is independent of α. Chen and Wornell showed that the watermark performance can be optimized by choosing α so that

$$α = \frac{DNR}{DNR + 1} ,$$

Where DNR=Dₘ/σ².

Development of Space-Filling Quantizers for QIM

Two Dimensions

FIG. 3 shows how dithered uniform scalar QIM can be extended to QIM using optimal uniform two dimensional quantizers. In the one dimensional case, the Figure shows a region of [symbol] ¹ (one-dimensional real number set) which is partitioned into two decision regions, one for each possible message value. Each decision region contains a code value at its centroid and is a polytope with minimal second moment about its centroid (in this case, trivially, an interval). By tiling [symbol] ¹ with the two decision regions and codevalues, it is possible to construct the quantizers shown in FIG. 2.

The right side of FIG. 3 shows a similar diagram in two dimensions. Here the optimal space-filling polytope is the hexagon; correspondingly, a region of [symbol] ² (two dimensional real number set) is partitioned into three hexagons, each with a code value at its centroid. Tiling [symbol] ² with this region results in a hexagonal lattice; each lattice point is assigned to one of three quantizers, and each of the three quantizers themselves have code values in a hexagonal sublattice of the original lattice. If code value C₀_{₀} is chosen to lie on the origin, then the lattice of all code values consists of:

$$\{ p : p = Um , m ∈ {Z}^{2} \} , where U = [ \begin{matrix}0 & \sqrt{3 Δ} \\ 2 Δ & Δ\end{matrix} ] ;$$

where Z is two-dimensional set of integers.

The lattices of the three quantizer's codevalues are given by

$${Q}_{i} = \{ p : p = Vm + {o}_{i} , m ∈ {Z}^{2} \} , \\ where V = [ \begin{matrix}- \sqrt{3 Δ} & \sqrt{3 Δ} \\ 3 Δ & 3 Δ\end{matrix} ] , \\ {o}_{0} = [ \begin{matrix}0 \\ 0\end{matrix} ] , {o}_{1} = [ \begin{matrix}0 \\ 2 Δ\end{matrix} ] , {o}_{2} = [ \begin{matrix}\sqrt{3 Δ} \\ Δ\end{matrix} ] .$$

Higher Dimensions

To get an idea of the performance which can be achieved from large dimensional quantizers having only a space-filling gain, the previous two dimensional case can be extended to an arbitrarily large number of dimensions n. To simplify the analysis, it will be convenient to apply some results of high resolution quantization theory, which assumes that quantizers have sufficient output levels so that the source probability distribution is essentially uniform within each quantization cell. The results of the analysis will be valid to the extent that the watermark distortion constraint Dₘ is small in comparison to the variance of the watermark source.

Here it will be assumed that the watermark signal channel is an Additive White Gaussian Noise (AWGN) channel with variance σ^{r}. For large n the channel noise will, with high probability, lie within an n-dimensional sphere of radius \sqrt{nσ²}. Thus if the decision regions of the watermark decoder are spheres of that size centered about the corresponding quantizer codevalues, the probability of watermark decoding error will approach zero with increasing n. Maximizing the watermark message rate for a given watermark distortion constraint is equivalent to solving an n-dimensional sphere packing problem similar to a problem that can be used to show the capacity of the Gaussian channel.

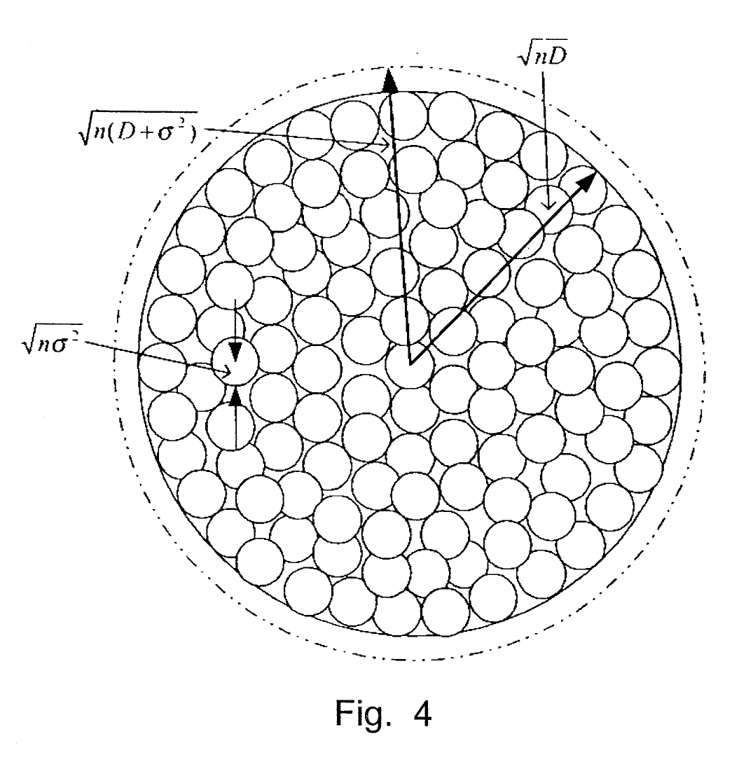

This is illustrated in FIG. 4, in which one decoding sphere for each possible message value is packed within a larger sphere. [symbol] ⁿ (an n-dimensional space of real numbers) can be tiled with this larger sphere to produce the set of all decoding regions used by the decoder. Each quantizer of the watermark encoder has quantization cells which are spheres of the same size as the larger sphere in FIG. 4. These quantization cells are packed tightly to fill [symbol] ⁿ. Each of the quantizers is identical except for an offset in [symbol] ⁿ corresponding to the location of the corresponding decoding sphere in FIG. 4. The capacity of this idealized QIM is given by the ratio of the volumes of the smaller and larger n-dimensional spheres. The larger sphere must have a normalized second moment about its centroid equal to nDₘ, the distortion constraint. This is given by

$$\frac{n}{n + 2} {r}^{2} = {nD}_{m} .$$

For large n, the radius of the larger sphere approaches \sqrt{nDₘ}. Since the volume of an n-dimensional sphere is kₙrⁿ, the maximum number of decoding spheres that can fit inside the larger sphere is:

$$\frac{{( {k}_{n} ( {nD}_{m} ) )}^{n / 2}}{{( {k}_{n} ( n {σ}^{2} ) )}^{n / 2}} = {2}^{\frac{n}{2} log \frac{Dm}{{σ}^{2}}} .$$

This results in an operational watermark capacity for this space-filling QIM of

$$C = \frac{1}{2} log \frac{{D}_{m}}{{σ}^{2}}$$

bits per sample. If the source X₁^{N} is iid Gaussian, the watermark capacity is given by

$$C = \frac{1}{2} log ( \frac{{D}_{m}}{{σ}^{2}} + 1 )$$

It is interesting to note that if the outer sphere with radius \sqrt{n(Dₘ+σ²)} shown in FIG. 4 is packed with decoding spheres of radius \sqrt{nσ²}, exactly enough decoding spheres fit to reach capacity; a QIM scheme using this larger sphere, however, would not satisfy the distortion constraint Dₘ.

Higher Dimension Distortion Compensated QIM

The capacity of a higher dimensional distortion compensated QIM can be analyzed in a similar manner to the previous case. The larger sphere available for packing of decoding spheres has a radius of

$${r}_{large} = \frac{\sqrt{n {D}_{m}}}{α} = \frac{( {D}_{m} + {σ}^{2} )}{{D}_{m}} \sqrt{{nD}_{m}} .$$

The distortion compensated watermarked signal will lie within a sphere of radius

$${r}_{D C} = ( 1 - α ) {r}_{large} = \frac{{σ}^{2} \sqrt{n {D}_{m}}}{{D}_{m}}$$

centered about each quantizer reconstruction value. Each decoding sphere contains the sum of the distortion compensated watermark signal and the channel noise. Since these two are independent, each decoding sphere has a radius of

$${r}_{decode} = \sqrt{( \frac{{σ}^{4}}{{D}_{m}^{2}} ) n {D}_{m} + n {σ}^{2}} = \sqrt{n {σ}^{2} ( \frac{{σ}^{2} + {D}_{m}}{{D}_{m}} )} .$$

Taking the ratio of the volumes of the two spheres gives a capacity of

$$C = \frac{1}{2} log \frac{{D}_{m}}{{σ}^{2}}$$

bits per sample, exactly reaching the theoretical capacity.

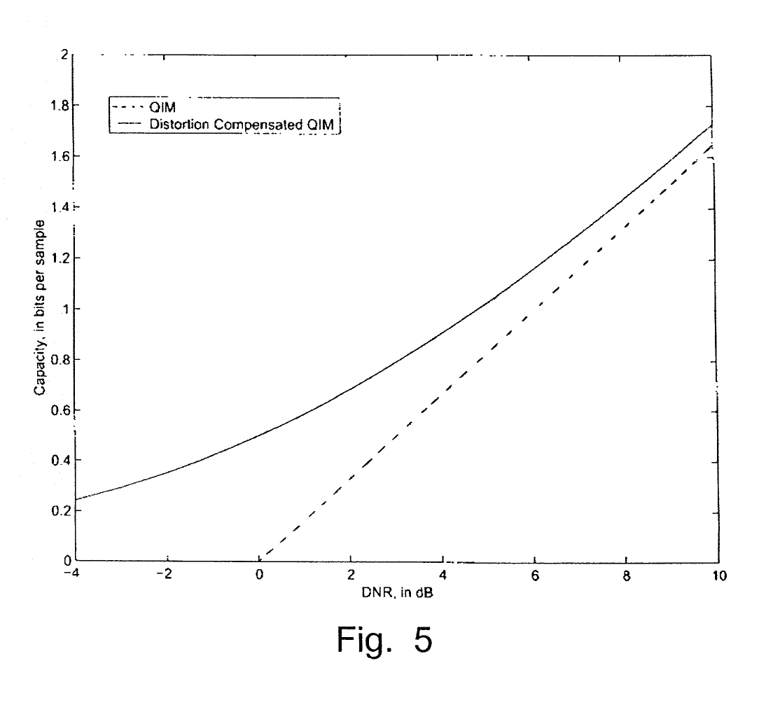

FIG. 5 compares the idealized high dimension space-filling QIM performance with and without distortion compensation.

Performance Examples

To investigate how vector quantizers with different types of quantization gain perform in a QIM application, QIM using three types of quantizers were implemented. The first quantizer was the dithered scalar quantization proposed by Chen and Wornell. The second was the hexagonal lattice quantizer described above. The final type of quantizer simulated for QIM was a structured vector quantizer (SVQ). In all cases the QIM used a blocklength of 32 samples in which either one of two messages (for dithered scalar QIM and SVQ QIM) or one of three messages (for 2-D hexagonal lattice QIM) was embedded. In the case of 2-D QIM, the same message was embedded in each of 16 pairs of samples in the 32 sample block.

The message can be used to represent an auxiliary data symbol (e.g., binary, M-ary, etc.). Groups of redundant or different symbols may be formed into a digital watermark message payload and embedded in the source media signal. To embed such a payload, the encoder maps the messages to corresponding samples, or blocks of samples, in the source signal. These samples may be spatial, time, frequency, or some other transform domain sample of the source signal.

Examples of multi-dimensional quantizers that can be used for QIM watermarking include trellis coded quantizers and lattice vector quantizers, such as a hexagonal lattice quantizer. These multi-dimensional quantizers enable exploitation of the shape filling gain described above.

Structured Vector Quantizers and QIM

SVQ exhibits no space filling gain, but does take advantage of the available shape gain. It is able to achieve the performance of an entropy coded quantizer, but at a fixed bit rate. The first step in designing an n-dimensional SVQ is to first design an N level entropy coded scalar quantizer and to calculate the codeword lengths corresponding to each of the quantizer's levels. Then an n-dimensional product codebook, containing Nⁿ codevectors of length n is formed. Each vector in the product codebook is assigned a length corresponding to the sum of the lengths of the corresponding scalar quantizer codeword outputs. Then a threshold T≈nH (X), where H(X) is the entropy of the source is chosen. Finally each codevector with a length greater than T is then removed from the product codebook. Source vectors of length n are then quantized to the closest codevector in the remaining codebook. The number of bits required to represent each codevector is approximately T, which is less than nlog₂N. As block length increases, the performance of the SVQ approaches the distortion and rate performance of the original entropy coded scalar quantizer.

For QIM, two SVQs were designed, both with block lengths of 32 samples. The scalar quantizers used as the basis of these two SVQs were dithered uniform scalar quantizers. Logarithms of scalar quantizer probabilities were used instead of codeword lengths.

Results

Since the message size is different for the 2-D hexagonal lattice QIM than for the other two types of QIM, they cannot be directly compared by using the resulting probabilities of decoding error. Instead, the delivered channel capacities are derived from the decoding error probabilities and compared. The channel capacities are given by:

C_{DITHER}=1.0+Pₑᵣᵣlog(Pₑᵣᵣ)+(1−Pₑᵣᵣ)log(1−Pₑᵣᵣ),

C_{SVQ}=1.0+Pₑᵣᵣlog(Pₑᵣᵣ)+(1−Pₑᵣᵣ)log(1−Pₑᵣᵣ),

C_{HEX}=log(3)+Pₑᵣᵣlog(Pₑᵣᵣ/2)+(1−Pₑᵣᵣ)log(1−Pₑᵣᵣ).

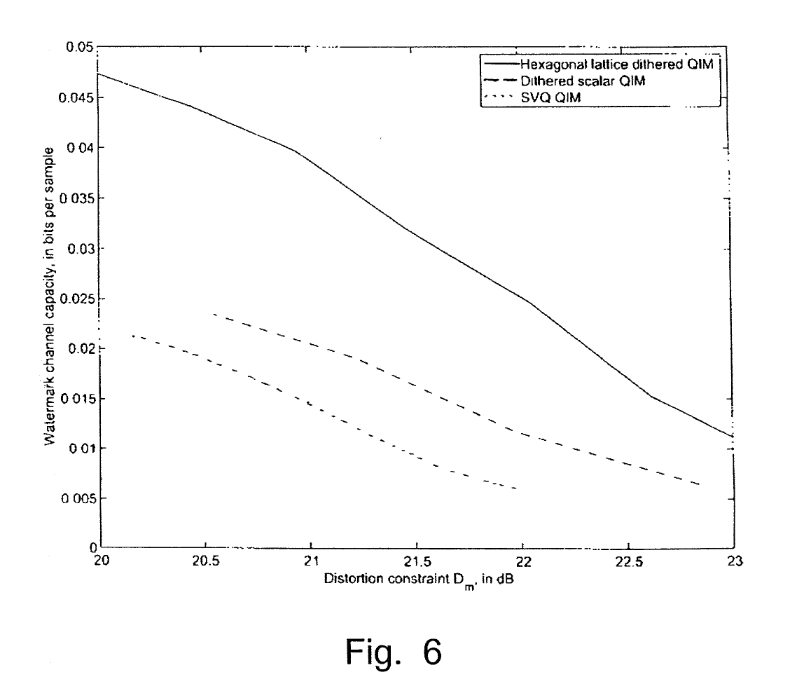

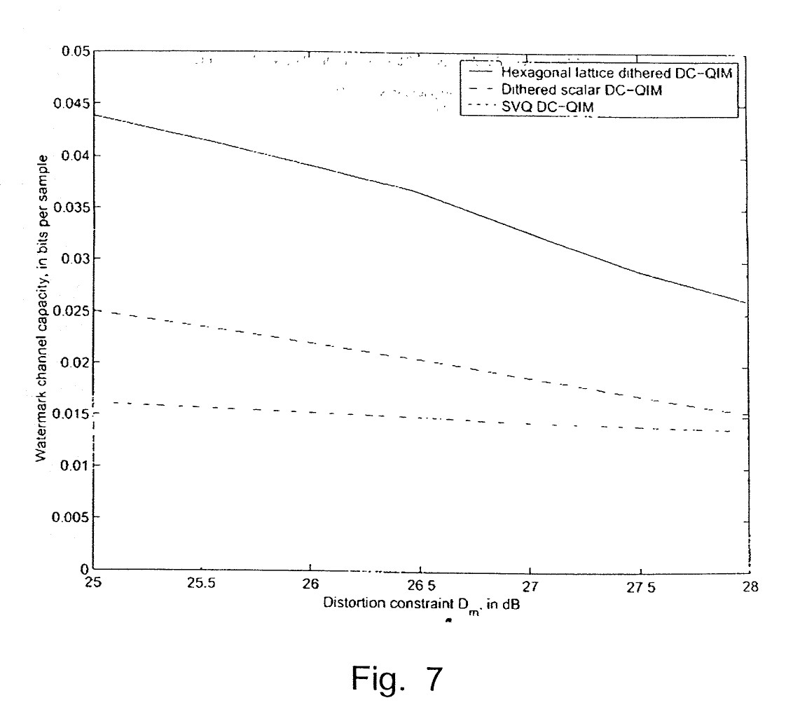

FIG. 6 shows the results for a unit variance Gaussian source with AWGN of 22dB. The hexagonal lattice based QIM performed the best, followed by the dithered scalar QIM, and the SVQ QIM had the poorest performance. The loss in performance between the dithered scalar quantizer and SVQ is most likely due to a slight decline in the distortion characteristics of the SVQ, when compared with the original scalar quantizer it was designed from. In a compression application, this decline is more than compensated for by the lower rate requirement of the SVQ compared with the scalar quantizer. Since encoding rate is not important for QIM, this advantage does not accrue to the SVQ QIM.

The hexagonal lattice based QIM performed significantly better than the dithered scalar quantizer; in most cases the capacity of the hexagonal lattice QIM was approximately twice the capacity of the dithered scalar QIM.

Concluding Remarks

The results of the previous section have shown that it is possible to improve QIM performance by using a quantizer which provides a space-filling gain; the results have also shown that quantizers which provide a shape gain do not necessarily improve QIM performance. The capacity argument presented above implies that, asymptotically in block length and quantizer resolution, space filling gain alone may be enough to achieve watermarking capacity in distortion compensated QIM.

Having described and illustrated the principles of the technology with reference to specific implementations in the attached paper and documents incorporated by reference, it will be recognized that the technology can be implemented in many other, different, forms. To provide a comprehensive disclosure without unduly lengthening the specification, applicants incorporate by reference the patents and patent applications referenced above.

The methods, processes, and systems described above may be implemented in hardware, software or a combination of hardware and software. For example, the auxiliary data encoding processes may be implemented in a programmable computer or a special purpose digital circuit. Similarly, auxiliary data decoding may be implemented in software, firmware, hardware, or combinations of software, firmware and hardware. The methods and processes described above may be implemented in programs executed from a system's memory (a computer readable medium, such as an electronic, optical or magnetic storage device).

The particular combinations of elements and features in the above-detailed embodiments are exemplary only; the interchanging and substitution of these teachings with other teachings in this and the incorporated-by-reference patents/applications are also contemplated.

I claim

1. A method of digital watermark embedding of messages in a media signal using quantization index modulation comprising:
receiving samples of the media signal;
receiving a watermark payload comprised of messages;
embedding the messages by quantizing samples of the media signal with multi-dimensional space filling quantizers corresponding to values of the messages being embedded.

2. The method of claim 1 wherein the space filling quantizers comprise lattice vector quantizers.

3. The method of claim 1 wherein the space filling quantizers comprise trellis code quantizers.

4. A computer readable medium comprising instructions for performing the method of claim 1.

5. A method of digital watermark decoding of messages in a media signal using quantization index modulation comprising:
receiving samples of the media signal;
quantizing the samples with multi-dimensional space filling quantizers corresponding to possible message values;
determining from the quantizing which of the possible message values is embedded in the samples of the media signal.

6. The method of claim 5 wherein the space filling quantizers comprise lattice vector quantizers.

7. The method of claim 5 wherein the space filling quantizers comprise trellis code quantizers.

8. A computer readable medium comprising instructions for performing the method of claim 5.
